(19) United States
(12) Patent Application Publication
(10) Pub. No.: US 2005/0214189 A1
(43) Pub. Date: Sep. 29, 2005

(54) Dry scrubber/collector

(76) Inventor: Ronald F. Balingit, Agoura Hills, CA (US)

Correspondence Address: Ronald F. Balingit, 6320 Meadow Haven Drive, Agoura Hills, CA, 91301, US

(21) Appl. No.: 10/812,240

(22) Filed: Mar. 29, 2004

(51) Int. Cl. B01D 53/50

(52) U.S. Cl. 423/243.01

(57) ABSTRACT

A process of removing sulfur compounds and particulates from a gas such that the gas is relatively dry after undergoing said process comprising the steps of (a) spraying separately controlled amounts of chemical reagent and water into the gas inside an enclosure; and (b) collecting the products of the chemical reaction and particulates inside said enclosure with the condensate on a solid surface, also inside said enclosure, whose temperature is kept from exceeding the dew point temperature of the gas by external cooling. A process which does not use a separate particulate collector and which utilizes the fly-trap effect: the trapping of suspended particles on a wet surface enhanced by the lower total pressure caused by condensation.

### BACKGROUND OF THE INVENTION

A. Field of the Invention

This invention relates to flue gas scrubbers, specifically to a dry scrubber/collector.

B. Description of the Prior Art

Prior art flue gas scrubbers can be classified based on the relative humidity of the flue gas leaving the scrubber as wet, when the relative humidity is close to or exceeds 100%, or dry, when it is otherwise.

Wet scrubbers remove sulfur compounds from the flue gas by causing physical contact between the flue gas and a mixture of a chemical reagent and water. Physical contact is achieved by using sprays or curtains of the mixture. Particulates and the products of the chemical reaction are collected as a slurry with the mixture. For a wet scrubber that recycles the mixture, significant water makeup is necessary to replace the water evaporated and carried away by the flue gas. To improve stack plume appearance and to increase plume buoyancy, flue gas reheating is necessary. The increased volume of the flue gas and water vapor will increase the induced draft fan power power requirement.

Dry scrubbers remove sulfur compounds from the flue gas by causing physical contact between the flue gas and a chemical reagent in pure form or mixed with a small amount of water. One method of achieving physical contact is by spraying the chemical reagent into the flue gas. This method requires a particulate collector such as a bag filter to collect the products of the chemical reaction. Another method of achieving physical contact is by passing the flue gas through a porous surface containing the chemical reagent. This method requires periodic cleaning of the porous surface. The increased pressure drop as the chemical reagent, products of the chemical reaction, and particulates accumulate on the porous surface will cause a significant increase in induced draft fan power requirement.

The process for removing acid components from gas streams by Rochelle, et al., U.S. Pat. No. 5,401,481, discloses a dry scrubber without a particulate collector. The apparatus for dry scrubbing a hot gas and start up process by Bresowar, U.S. Pat. No. 4,812,295, discloses a dry scrubber using a filter during start up and later a movable mat for particulate collection. The integrated injection and bag filter house system by Doyle, et al., U.S. Pat. No. 4,793,981, discloses a dry scrubber using bag filters for particulate collection. The air washer/scrubber by Telchuk, Jr., et al., U.S. Pat. No. 4,328,012, discloses a wet scrubber.

### SUMMARY OF THE INVENTION

### A. OBJECTS AND ADVANTAGES

This invention will provide a dry scrubber/collector:
a) which will not require significant water makeup,
b) which will not require a separate particulate collector,
c) which will not require reheating of the flue gas, and
d) which will not cause a significant increase in induced draft fan power requirement.

This invention will also provide a dry scrubber/collector:
a) whose shape and dimensions can be made to satisfy a specific application, and
b) which will reduce air pollution for the benefit of the public and the environment.

Further objects and advantages of this invention will become apparent from a consideration of the drawings and ensuing description.

### B. DESCRIPTION OF THE INVENTION

This invention is a modified application of a process described in my other invention the Smoke Collector for Diesel Engines, application Ser. No. 10/783,224, filed 20 Feb. 2004.

This invention is a process for removing sulfur compounds and particulates from the flue gas comprising the steps of:
a) injecting a mixture of a chemical reagent and water into the flue gas, and
b) compelling the flue gas to interact with a solid surface whose temperature does not exceed the dew point temperature of the flue gas.

Control of the process is achieved by:
a) controlling the amount of chemical reagent mixed with the water,
b) controlling the amount of water,
c) controlling the movement of the flue gas to force the flue gas to flow near said solid surface,
d) controlling the rate of cooling of said solid surface to keep the temperature of said solid surface from exceeding the dew point temperature of the flue gas, and
e) controlling the cleanliness of said solid surface by removing collected particulates and condensate from said solid surface.

### C. MATERIAL OF THE INVENTION

Due to the corrosiveness of the condensate and collected particulates, it is necessary to use materials which can withstand that corrosiveness.

Materials commonly used in the industry to withstand corrosiveness include: glass, porcelain, stainless steel for making mufflers and exhaust pipes of vehicles, enamel-covered mild steel commonly used in the manufacture of air preheater baskets of regenerative air preheaters of steam generators, and cast iron or mild steel coated with a material used in the manufacture of household pots and pans.

For the components that will not come in contact with the condensate and particulates, ordinary materials such as cast iron and mild steel can be used.

### DRAWINGS OF THE INVENTION

### A. BRIEF DESCRIPTION OF THE DRAWINGS

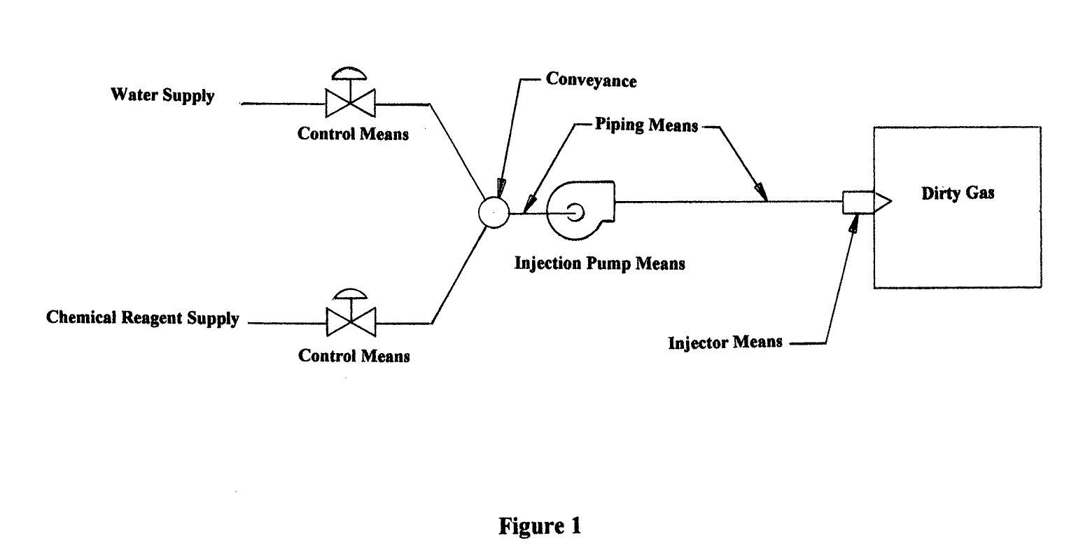

FIG. 1 is a schematic diagram of the chemical reagent and water injection system.

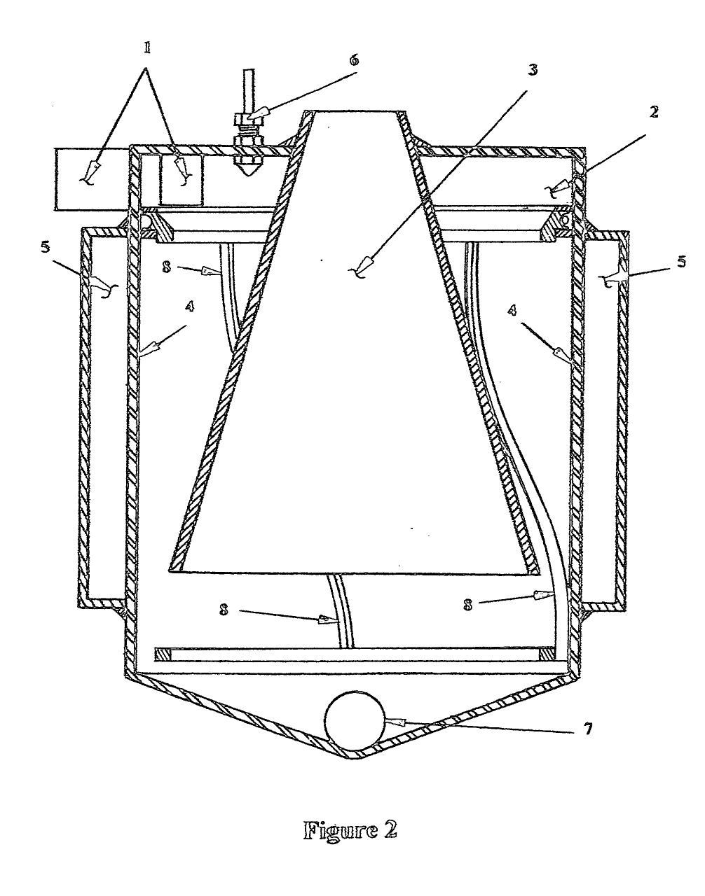

FIG. 2 is cross section of one embodiment of the particulate trapper.

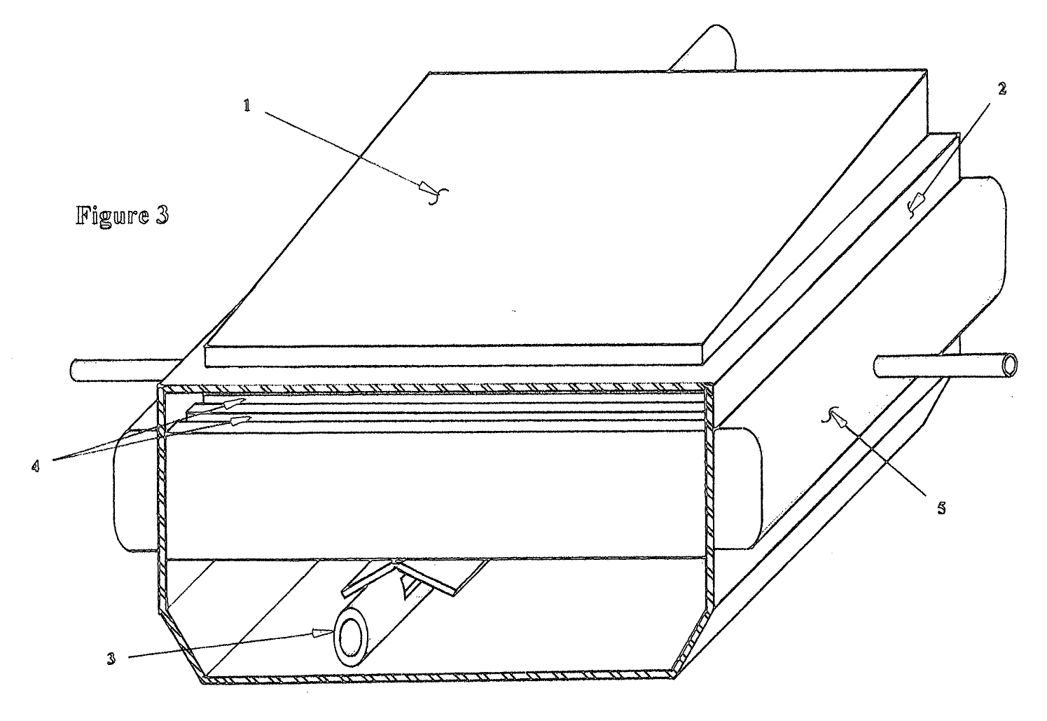

FIG. 3 is an isometric drawing, with one face of the enclosure removed, of another embodiment of the particulate trapper.

### B. LIST OF REFERENCE NUMERALS

1—inlet means
2—enclosure
3—outlet means
4—solid surface
5—cooling means
6—injector means
7—opening for conveyance of condensate and particulates
8—cleaning means

### C. DETAILED DESCRIPTION OF THE DRAWINGS

This invention is a process for removing sulfur compounds and particulates from a flue gas using common devices and a new device that operates under a new concept.

FIG. 1 shows a schematic drawing of said process.

The two basic components of said process are: a Chemical Reagent and Water Injection System, and a 5 Particulate Trapper.

The flue gas containing the sulfur compounds and particulates to be removed is referred to as dirty gas and the flue gas leaving said Particulate Trapper is referred to as clean gas.

The following describes the basic components of said process.

Chemical Reagent and Water Injection System

The chemical reagent and water injection system is comprised of:
a) a water supply with a flow control means,
b) a chemical reagent supply with a flow control means,
c) a conveyance where the chemical reagent and water are introduced,
d) an injection pump means whose suction is connected to said conveyance,
e) a piping means connected to the discharge of said injection pump means to deliver the mixture of the chemical reagent and water to an injector means, and
f) said injector means positioned so as to inject said mixture into the dirty gas.

FIG. 1 is a schematic diagram of said Chemical Reagent and Water Injection System.

Said water supply flow control means will control the flow of water to ensure the flue gas in said Particulate Trapper will not be supersaturated.

Said chemical reagent supply flow control means will control the flow of the chemical reagent as a function of the amount of sulfur compounds in the flue gas.

Said injection pump means will develop sufficient pressure to ensure proper atomization of the mixture of the chemical reagent and water at the discharge of said injector means.

Chemical reagent and water injection systems are common in the industry and can be designed and manufactured using known engineering principles and manufacturing processes, respectively.

Particulate Trapper

A Particulate Trapper comprising:
a) said solid surface inside an enclosure,
b) said enclosure with an inlet means for admitting the dirty gas and an outlet means for allowing clean gas to exit said enclosure,
c) a cooling means for keeping the temperature of said solid surface from exceeding the dew point temperature of the dirty gas, and
d) a cleaning means for removing collected particulates and condensate from said solid surface.

The elements composing said Particulate Trapper can be embodied in several ways. For this reason said Particulate Trapper can have numerous embodiments.

Said solid surface can be planar, cylindrical, other geometric shapes or combinations of geometric shapes.

Said enclosure can be a parallelepiped, cylindrical, other geometric shapes or combinations of geometric shapes.

Said cooling means can be cooling fins for natural draft or forced draft air cooling, a water jacket with a separate radiator, a water jacket connected to an existing radiator, a water jacket cooled by a refrigerant, and direct cooling with a refrigerant.

Said cleaning means can be a water spray inside said enclosure, positively driven scrapers or wipers inside said enclosure or a combination of the two.

To provide some specificity and to help visualize the concept of sulfur compound and particulate removal, the following will be used here.

A vertical cylinder sheet covered at both ends as an embodiment of said enclosure.

The inside wall of said vertical cylinder sheet as an embodiment of said solid surface.

A rectangular tube with one face tangential to said solid surface as an embodiment of said inlet means.

A conical section sheet located inside and coaxial with said vertical cylinder sheet with the smaller end of said conical section sheet connected to the top cover of said vertical cylinder sheet as an embodiment of said outlet means.

A water jacket on the outside of said vertical cylinder sheet as an embodiment of said cooling means.

A plurality of helical scrapers inside said enclosure with a worm gear and a worm drive as an embodiment of said cleaning means.

FIG. 2 shows a cross section, along the axis of said vertical cylinder sheet, as the embodiment of said Particulate Trapper with these elements.

Using FIG. 2, sulfur compound and particulate collection is described below.

Dirty gas enters enclosure 2 through inlet means 1. Once inside, the gas will revolve around outlet means 3 and will come in contact with solid surface 4. Because the temperature of solid surface 4 will not exceed the dew point temperature of the gas, water vapor will condense on solid surface 4. Particulates coming in contact with the condensate will be trapped. More particulates will be trapped as more condensate forms on solid surface 4 and on the particulates already trapped there. This can be called the “fly-trap” effect. Sulfur compounds coming in contact with the chemical reagent will form solid products of the chemical reaction. The solid products will be trapped on said solid surface as they come in contact with the condensate on the surface. Sulfur compounds in the dirty gas coming in contact with the condensate will chemically react with the condensate to form acidic products.

As water vapor condenses on solid surface 4 and on the trapped particulates, the partial pressure of water vapor near solid surface 4 will decrease creating localized spaces near solid surface 4 with a lower total pressure, as defined by Dalton's law, than the main gas stream. This lower total pressure will create a potential for the main gas stream to flow toward solid surface 4. This will further enhance the fly-trap effect.

As the gas spirals toward the bottom of enclosure 2, the gas is forced to move closer and closer to solid surface 4 by outlet means 3, thereby increasing the chance for capture of more sulfur compounds and particulates.

Clean gas exits through the opening at the bottom of outlet means 3. Because the opening at the bottom is bigger than the opening at the top, reentraimnent of collected condensate and particulates is minimized. Outlet means 3 provides two beneficial roles: to force the gas to move closer to solid surface 4 and to minimize reentrainment of collected particulates.

Cooling means 5 will transfer heat from solid surface 4 to the surroundings. The rate of heat transfer will be controlled to ensure that the temperature of solid surface 4 will not exceed the dew point temperature of the dirty gas.

Cleaning means 8 will remove condensate and trapped particulates from solid surface 4 and convey the material removed to the bottom of enclosure 2 for storage or disposal. The mode of operation of cleaning means 8 will be controlled to ensure a sufficient area of solid surface 4 is relatively clean at all times.

Compelling the flue gas to interact with solid surface 4 is achieved by: admitting the gas into enclosure 2, creating localized low pressure spaces near solid surface 4, and forcing the gas to move closer and closer to solid surface 4.

An opening, marked 7, in FIG. 2 is for allowing the conveyance of particulates and condensate from said Particulate Trapper to a separate storage container.

FIG. 3 is an isometric drawing of another embodiment of said Particulate Trapper with one face of said enclosure removed to show the internal elements. This embodiment shows, among other things, water-cooled plates making up said solid surface, an inlet header to distribute the dirty gas evenly across the plates as said inlet means, and a box-like enclosure.

Other Applications of this Invention

Diesel Engines: sulfur compound and smoke scrubber/collector to reduce exhaust emmissions.

Air Conditioning Pretreatment: Water vapor and smoke scrubber/collector to reduce the latent heat load of the air conditioning system.

1. (canceled)

2. (canceled)

3. (canceled)

4. (canceled)

5. (canceled)

6. (canceled)

7. (canceled)

8. (canceled)

9. (canceled)

10. A process of removing sulfur compounds and particulates from a gas comprising the steps of
(a) spraying separately controlled functional amounts of a chemical reagent and water into the flue gas inside an enclosure wherein said enclosure has an inlet and an outlet for the gas; and
(b) collecting the products of the chemical reaction and particulates inside said enclosure with water condensate on a solid surface, also inside said enclosure, whose temperature is kept from exceeding the dew point temperature of the gas by heat transfer to an external cooling means.

11. The process according to claim 1 wherein chemical reagent and water are sprayed into the gas by an injector.

12. (canceled)

13. (canceled)

14. The process according to claim 1 wherein said external cooling means is a plurality of air-cooled cooling fins.

15. The process according to claim 1 wherein said solid surface is cleaned of collected condensate and particulates by a plurality of scrapers.

16. The process according to claim 1 wherein the amount of chemical reagent is controlled by a chemical reagent supply flow controller.

17. The process according to claim 1 wherein the amount of water is controlled to prevent supersaturating the gas by a water supply flow controller.

18. The process according to claim 1 wherein said external cooling means is a water jacket.

19. The process according to claim 1 wherein said external cooling means is a refrigerant.

20. The process according to claim 1 wherein said solid surface is cleaned of collected condensate and particulates by a water spray.
